(19) United States
(12) Patent Application Publication
(10) Pub. No.: US 2025/0376131 A1
(43) Pub. Date: Dec. 11, 2025

(54) WINDSCREEN WIPING INSERT WITH A ROW OF BRUSHES AND WINDSCREEN WIPER

(71) Applicant: BET STREAM PTY LTD, Victoria (AU)

(72) Inventors: Àkos ÉVA, Siófok (HU); Ryan GORDON, Victoria (AU); Joseph STANLEY, Victoria (AU); Antonio DRAPER, Victoria (AU)

(21) Appl. No.: 18/546,382

(22) PCT Filed: Feb. 15, 2022
(86) PCT No.: PCT/HU2022/050010

§ 371 Date: Aug. 14, 2023

(30) Foreign Application Priority Data
Feb. 15, 2021 (HU) P2100049
Oct. 25, 2021 (HU) P2100367

(51) Int. Cl. B60S 1/38; A46B 9/00; A46B 9/06; A46B 15/00; A46D 1/00; B60S 1/56

(52) U.S. Cl. CPC B60S 1/38; A46B 9/005; A46B 9/06; A46B 15/0081; A46D 1/0207; B60S 1/56; A46B 2200/3046; B60S 2001/3812; B60S 2001/3834

(57) ABSTRACT

A replaceable windscreen wiping insert forming part of a wiper which is provided with a row of brushes for cleaning a vehicle's windscreens and headlights. The wiping insert includes an elongated base member having a connecting element for attaching it to a wiper adapter; at least one wiping blade extending from the base member along the length thereof and being deflected relative thereto during use; and at least one row of brushes arranged along the length of the base member. The at least one row of brushes is integrated directly into the wiping blade such that the row of brushes is arranged projecting from a first longitudinal side of the wiping blade or from a second longitudinal side opposite thereto. The disclosure also relates to a windscreen wiper including the wiping insert and to a method for retrofitting available wiping inserts with a row of brushes.

### TECHNICAL FIELD

The present invention relates to a replaceable windscreen wiping insert forming part of a windscreen wiper which is provided with a row of brushes for cleaning the outer surfaces of various motor vehicles, in particular windscreens and headlights. The invention also relates to a windscreen wiper provided with such a windscreen wiping insert. The invention further relates to a method for retrofitting available windscreen wiping inserts with a row of brushes.

Conventional windscreen wipers are generally equipped with a windscreen wiping insert ending in a rubber wiping blade that is clamped to the windscreen of a vehicle by a spring structure. The windscreen wiping insert can be placed into a windscreen wiper adapter that is attached to the driving mechanism of the windscreen wiper.

As the windscreen wiper is moving (alternatingly), the wiping blade can easily remove rainwater or non-frozen snow from the windscreen, but conventional windscreen wipers can barely cope with snow, ice, or sleet frozen on the windshield or windscreen. The removal of insect remnants and other contaminants from the windscreen is also difficult, and these deposits are usually chemically cleaned by using windshield washer fluids, but their excessive use due to stubborn dirt is a significant environmental burden.

### BACKGROUND ART

The prior art also offers a number of solutions to enhance the mechanical surface cleaning effect of the wiping blade by arranging additional elements, such as rows of brushes on the windscreen wiping insert. These require the arrangement of relatively complex brush-supporting elements in terms of form and technology, which in each case must be designed during production.

EP0100622 B1 discloses a complex wiping blade, which is considered to be the closest piece of prior art. It combines the above cleaning solutions. On the one hand, cleaning fluid can be supplied during operation to the area in front of the windscreen through the passages formed in the windscreen wiper.

On the other hand, embracing the wiping blade, two brush holder elements are arranged on the windscreen wiping insert, each serving to fasten a row of brushes parallel to the wiping blade. Although this allows the additional cleaning effect of the given row of brushes to take place during the movement of the wiping blade therefore in both directions, they make a rather robust, complicated to produce solution due to the special design of the brush holder elements.

ES2556146A1 relates to a combined windscreen wiper comprising two wiping blades arranged parallel to each other, with a row of brushes extending between them and in parallel with them. During use, the row of brushes is in a substantially perpendicular contact with the surface to be cleaned.

The drawback of the invention is that it does not provide a suitable solution for wiping those glass surfaces with the rubber wiping blade of the windscreen wiper that have previously been cleaned of stubborn dirt. Thereby, firstly there is a risk of scratching the glass surface, and the wiping blade is also subjected to a greater abrasion effect than if it were to pass through a surface free of dirt; so it wears out prematurely. Further disadvantages of the invention are the double material consumption and the higher manufacturing cost due to the double wiping blade.

The invention taught in GB2132077A is an attachment for attaching to a windscreen wiper comprising one or two rows of brushes. In our view, the use of this invention is economically disadvantageous because, although the attachment can be manufactured at a relatively low cost, it should be used mounted on a conventional windscreen wiper, thus the overall cost is significant.

The disadvantage of its application is that it is difficult to attach the attachment to the windscreen wiper, and the version of the attachment with two rows of brushes is particularly complicated to attach. When used, some backlash resulting from the flexibility of the attachment is generated by the (alternating) movement of the windscreen wiper, which can cause unwanted sound effects, distracting the attention of the driver. In addition, improper selection of the material may result in premature wear of the fastening strap material due to strong sunlight or frost, and the attachment will become detached from the wiper.

### SUMMARY OF THE INVENTION

It is an object of the present invention to provide an easy and inexpensive windscreen wiping insert that provides cleaning of a vehicle windscreen with increased efficiency.

It is a further object of the present invention to provide an effective windscreen wiper that does not impair the visibility of road conditions perceived by the driver.

It is also our goal to retrofit finished windscreen wipers that were not originally equipped with a row of brushes as a cost-effective accomplishment of the original purpose.

Our object is attained by a windscreen wiping insert for cleaning vehicle surfaces, in particular windscreens and headlights, wherein the windscreen wiping insert comprises an elongated base member having a connecting element for attaching the windscreen wiping insert to a windscreen wiper adapter; at least one wiping blade extending from the base member along the length thereof and being deflected relative to the base member during use; and at least one row of brushes arranged along the length of the base member, furthermore the at least one row of brushes is integrated directly into the wiping blade such that the at least one row of brushes is arranged projecting from a first longitudinal side and/or from a second longitudinal side opposite to the first longitudinal side of the wiping blade.

### BRIEF DESCRIPTION OF THE DRAWINGS

In the following, the invention will be described in detail with reference to the accompanying drawing. In the drawing

FIG. 1 is an exploded view of a prior art windscreen wiper with a wiper adapter serving as a support together with a wiping insert—without any rows of brushes—that can be connected thereto;

FIG. 2 shows a windscreen wiper in the assembled state with a wiper adapter comprising a wiping insert according to the present invention,

FIG. 3 shows one end of the windscreen wiper of FIG. 2 seen from a first direction of movement, and

FIG. 4 shows one end of the windscreen wiper of FIG. 2 seen from the other direction of movement.

### DETAILED DESCRIPTION

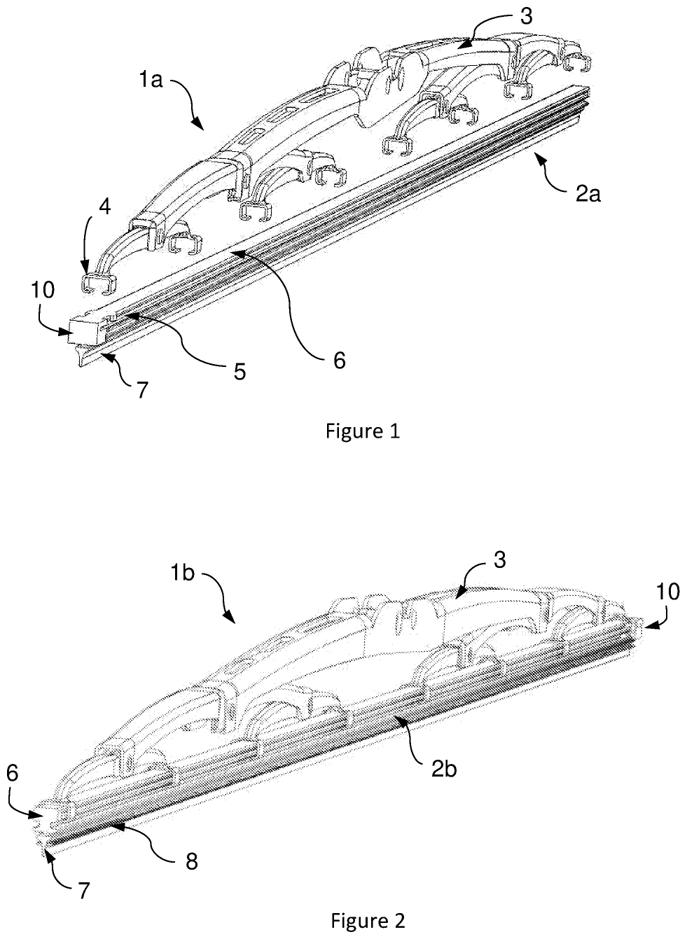

FIG. 1 shows a general windscreen wiper 1 a comprising a replaceable windscreen wiping insert 2a and a windscreen wiper adapter 3 holding the windscreen wiping insert 2a. The general windscreen wiper 1a (as well as the windscreen wiper 1b according to the invention) is used for cleaning the various external surfaces of motor vehicles, in particular windscreens and headlights.

FIGS. 1 to 4 show the most widely used frame version of the windscreen wiper adapter 3, which is provided with claws 4 for holding the wiping insert 2a, 2b. The windscreen wiper adapter 3 ensures the connection to the operating arm of the windscreen wiper driving mechanism (not shown).

In addition to the windscreen wiper adapter version illustrated in this description, the so-called flat-blade system in which a spring rail pushes the windscreen wiping insert onto the windshield is also becoming widespread. The windscreen wiping insert 2a, 2b is provided with a connecting element 5 for mounting on to the windscreen wiper adapter 3, which in the case of the types shown in the drawing, being a guide channel 5 provided on each side of the windscreen wiping insert 2a, 2b, in this case for receiving the claws 4. The replacement of a worn out windscreen wiping insert, i.e. the windscreen wiping insert 2a, 2b, can thus be carried out easily.

The windscreen wiping inserts 2a, 2b essentially comprise an elongated base member 6 and an elongated wiping blade 7 extending along the length of the base member 6, which are integrally molded from the same material, most commonly from rubber.

These two elongated elements are connected along their length by a thin, continuous material bridge 11 (indicated in FIG. 4), which is shown in FIGS. 1, 2 and 4, respectively. The elongated base member 6 comprises said connecting element 5. When in use, to achieve the desired cleaning effect the resilient material bridge 11 allows the elongated wiping blade 7 to deflect in a suitable extent into the opposite direction of the direction of movement relative to the base member 6, which ensures the connection to the rest of the windscreen wiper.

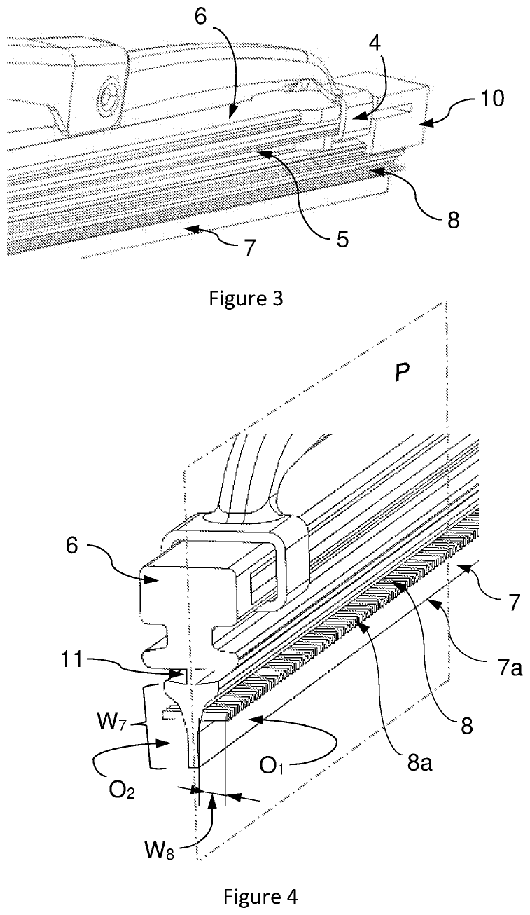

If required by the type of the connecting element 5 formed in the base member 6, the base member 6 also comprises a fastening element which prevents the windscreen wiping insert 2a, 2b from moving longitudinally (possibly falling out) relative to the windscreen wiper adapter 3; this fastening element (inter alia in FIG. 3) is illustrated by a stop 10.

The windscreen wiping insert 2a may generally comprise at least one row of brushes (not shown in FIG. 1), which is usually secured by separate row(s) of brush holders.

A characteristic of the windscreen wiping insert 2b illustrated in FIGS. 2-4 that it is provided with a row of brushes 8 integrated directly into the wiping blade 7.

It is further characterized in that the row of brushes 8 is arranged projecting from a first longitudinal side O₁ of the wiping blade 7 facing the direction of travel of the wiping blade 7 during use; and/or opposite to it, from a second longitudinal side O₂ of the wiping blade 7, i.e. opposite to the current direction of travel.

That is, a row of brushes 8 is arranged on at least one of the longitudinal wiping blade sides O₁, O₂ not perpendicular to the center plane P of the wiping blade 7 (FIG. 4).

In the embodiments of the present invention, a row of brushes 8 is preferably arranged on both longitudinal sides O₁, O₂ of the wiping blade 7, i.e. on the first longitudinal side O₁ and opposite to it, on the second longitudinal side O₂; thereby it is ensured that the at least one row of brushes 8 is always functioning during the movement of the wiping blade 7 in both directions thereof; furthermore, in the application of a suitable brush row width (W₈), the row of brushes 8 actually make contact with the surface of the windscreen-passing in front of the wiping blade 7, and thus removing more stubborn dirt (beetle, mud, ice, etc.). Meanwhile, the wiping blade 7 performs its original function undisturbed, pulling the water off the windscreen, and so providing a perfect view from the vehicle.

For a more stable connection, the at least one row of brushes 8 is preferably arranged in a (pre-) thickened section of the wiping blade 7 closer to the base member 6, as can be observed in the FIGS. 2-4.

It should be noted here that since the cross-section of the wiping blade 7—due mainly to the insertion of the thickened section—is of a substantially triangular shape, made up of a plurality of straight segments; under the first longitudinal side O₁ we mean an assembly of any side segments, which during operation of the windscreen wiper 1b, moving in an arbitrarily chosen first direction of travel, essentially face this direction, and are not perpendicular to the center plane P of the wiping blade 7; and the second longitudinal side O₂ means a set of all side segments that are opposite to the first longitudinal side O₁, i.e., being opposite and not perpendicular to the center plane P of the wiping blade 7.

Furthermore, since the wiping blade 7 has a symmetrical cross-section along most of its length, for the sake of simplicity it is considered in this description that the central plane P is substantially the same as the plane of symmetry along the length of the wiping blade 7.

According to a preferred embodiment of the invention, the row of brushes 8 is of a threaded design, in that sense, it is a row of brushes 8 passing through said central plane P.

Such a row of brushes 8 is preferably provided with bristles, the material of which is selected from the group consisting of plastic, titanium, tungsten, and any metal or metal alloy having a hardness less than that of glass (suitable for functioning as a windscreen or headlamp cover material), such as copper, brass, aluminum, mild steel, and combinations thereof; wherein the bristles are threaded through the wiping blade 7 using a needle-like tool.

The advantage of the above-listed metal bristle fibers is that they can be guided easily and precisely during threading and are more durable than plastic bristles. In the case of threaded row of brushes 8, two sub-versions can be distinguished: in the first version of threaded row of brushes 8, the bristles of the brush are arranged projecting out on both sides of the wiping blade 7, so that two rows of brushes 8 are formed simultaneously during stitching.

In the case of the other version of threaded row of brushes 8, the bristles of the brush extend on only one side of the wiper edge 7, so that only the ridge (the root) of the row of brushes 8 passes through said plane of symmetry (P).

According to another embodiment of the invention, the row of brushes 8 is provided with rubber bristles, wherein the row of brushes 8 and the wiping blade 7 are molded together in a suitable injection molding target tool.

If the bristles made of rubber cannot be produced in the size of a traditional bristle fineness, this version can still play a kind of pre-cleaning, pre-scraping even “rubbing” role before the working of the wiping blades 7. Depending on the design of the injection molding tool, one or two rows of brushes 8 made of the own material of the wiping blade 7 can easily be formed on one and/or the other side O₁, O₂ of the wiping blade 7.

While in the threaded embodiment, the row of brushes 8 are integrated in an original, finished wiping blade 7, the rubber row of brushes 8 is designed to be adhered to the wiping blade 7 during injection molding, i.e. during manufacture. In either case, it is therefore not necessary to add an additional brush row support element to any part of the windscreen wiping insert 1b, so that the ergonomic properties and the weight of its design do not change significantly. Thus, it does not lose from its functionality either; it indeed retains that.

In previous, prior art solutions comprising a row of brushes, this latter is generally connected to the base member in such a way that it is fixed in a brush holder specially designed for this purpose. In contrast, at the present invention, the row of brushes 8 is incorporated directly into the wiping blade 7. Accordingly, here the row of brushes 8 rotates together with the wiping blade 7 when it is being bent.

Preferably, the material of the wiping blade 7 and the row of brushes 8 are selected in such a way; further (as shown in FIG. 4) the width W₇ of the wiping blade 7 is at least as much bigger than the width W₈ of the row of brushes 8 projecting from the wiping blade 7, that when the wiping blade 7 is being deflected—in the respective direction—relative to the base member 6 during use, the free end 7a of the wiping blade 7 and the free end 8a of the row of brushes 8 (arranged preceding the wiping blade 7 in the current direction of travel), are in contact with the windscreen.

Moreover, in order to ensure the contact with the windscreen outlined above and to facilitate production, the at least one row of brushes 8 is preferably built into the wiping blade 7 perpendicular to the central plane P passing along the length of the wiping blade 7; in other words, the plane defined by the row of brushes 8 and the central plane P of the wiping blade 7 are perpendicular to each other (i.e. the at least one row of brushes 8 is inevitably arranged at an angle with respect to the first longitudinal side O₁ as well as the opposite second longitudinal side O₂,—more precisely, with certain side sections that make them up).

The base member 6 and the wiping blade 7 of the windscreen wiping insert 2b, together with the material bridge 11 connecting them, are made of a mixture of natural and synthetic rubber. These elements as well as the row of brushes 8 are preferably provided with a protective coating, wherein the material of the protective coating is, for example, graphite.

In summary, the advantage of the invention is that, in contrast to the previously known solutions, it is not necessary to develop and install separately controlled devices with complicated mechanics.

The row of brushes 8 also contributes to the even distribution of the windscreen-washer fluid, nevertheless the base member 6 and the wiping blade 7 are not subjected to the load of a separate brush row holder on one or either sides of the wiping blade 7, so the service life of the windscreen wiping insert 2b is extended.

The windscreen wiping insert 2b exerts its effect during normal operation, thereby increasing its efficiency. Due to the simplicity of the technology, a large increase in efficiency can be achieved at a relatively low cost.

Due to the arrangement of the row of brushes 8 according to the invention, no separate brush row holder is required, therefore the windscreen wiper does not obscure more of the field of view compared to conventional windscreen wipers without a row of brushes. Thus, the use (while driving) of this effective windscreen wiper does not reduce the visibility distracting the driver's attention, hence it increases driving safety.

Reaching the end of the windscreen wiper's functional life, solely the used original rubber insert or, if applicable, the used wiping insert 2b (with a row of brushes) according to the present invention should be replaced with a new wiping insert 2b when the material is worn out, which is an environment friendly solution.

Additionally, the product according to the invention exhibits an ergonomic and stylish image, which, although not essentially being the subject of a patent, can indirectly contribute to the dissemination and spread of the invention which enhances the safety of driving or the product according to the invention.

1. A windscreen wiping insert for cleaning vehicle windscreen and headlight surfaces, wherein the windscreen wiping insert comprises;
an elongated base member having a connecting element for attaching the windscreen wiping insert to a windscreen wiper adapter;
at least one wiping blade extending from the base member along a length thereof and being deflected relative to the base member during use;
wherein the at least one wiping blade has a first longitudinal side and an opposite second longitudinal side;
at least one row of brushes arranged along the length of the base member; and
wherein the at least one row of brushes is integrated directly into the at least one wiping blade such that the at least one row of brushes projects from either the first longitudinal side or the second longitudinal side of the at least one wiping blade.

2. The windscreen wiping insert according to claim 1, wherein the at least one wiping blade is made of a mixture of natural and synthetic rubber.

3. The windscreen wiping insert according to claim 1, wherein characterized in that the at least one row of brushes is provided with bristles; and wherein the bristles are threaded through the at least one wiping blade.

4. The windscreen wiping insert according to claim 1, wherein the at least one row of brushes is provided with bristles made of a mixture of natural and synthetic rubber.

5. The windscreen wiping insert according to claim 1, wherein the at least one row of brushes is built into the at least one wiping blade so that a plane defined by the at least one row of brushes is arranged perpendicular to a center plane extending along the length of the at least one wiping blade.

6. The windscreen wiping insert according to claim 1, wherein a width of the at least one wiping blade is larger than a width of the at least one row of brushes projecting from the wiping blade such that when the at least one wiping blade is being deflected relative to the base member during use, a free end of the at least one wiping blade and a free end of the at least one row of brushes arranged preceding the at least one wiping blade in a direction of travel thereof, are in contact with the vehicle windscreen and headlight surfaces to be cleaned.

7. The windscreen wiping insert according to claim 1, wherein the at least one wiping blade or the at least one row of brushes are provided with a protective coating.

8. A windscreen wiper for cleaning an outer surface of a vehicle's windscreens and headlights, wherein the windscreen wiper comprises:
a windscreen wiper adapter (3);
a replaceable windscreen wiping insert selectively engageable with the windscreen wiper adapter, wherein the replaceable windscreen wiping insert comprises:
an elongated base member having a connecting element for attaching the windscreen wiping insert to the windscreen wiper adapter;
a wiping blade extending from the base member along a length thereof and being deflected relative to the base member during use, wherein the wiping blade has a first longitudinal side opposite a second longitudinal side;
a row of brushes arranged along the length of the base member; and
wherein the row of brushes is integrated directly into the wiping blade such that the row of brushes projects from either of the first longitudinal side or the second longitudinal side of the wiping blade.

9. A method of providing a windscreen wiping insert as part of a windscreen wiper, said method comprising:
providing a wiping blade on the windscreen wiping insert; and
forming a row of brushes on the wiping blade.

10. The method according to claim 9, wherein forming the row of brushes on the wiping blade includes threading the row of brushes through the wiping blade.

11. The method according to claim 9, wherein forming the row of brushes includes injection molding the row of brushes integrally with the wiping blade.

12. The windscreen wiping insert according to claim 3, wherein the at least one row of brushes is made from a material, wherein the material is one of plastic, titanium, tungsten, and any other metal or metal alloy, and wherein the material has a hardness less than that of glass.

13. The windscreen wiping insert according to claim 3, wherein the at least one row of brushes is made from one of copper, brass, aluminum, mild steel, or a combination thereof.

14. The wiping insert according to claim 4, wherein the at least one row of brushes is made integrally with the wiping blade.

15. The wiping insert according to claim 4, wherein the at least one row of brushes and the wiping blade are made from a single material.
